(19) United States
(12) Patent Application Publication
(10) Pub. No.: US 2008/0278459 A1
(43) Pub. Date: Nov. 13, 2008

(54) Display Device

(75) Inventor: Keitaro Yamashita, Tokyo (JP)

Correspondence Address: BIRCH STEWART KOLASCH & BIRCH, PO BOX 747, FALLS CHURCH, VA, 22040-0747, US

(73) Assignee: KONINKLIJKE PHILIPA ELECTRONICS N.V., Eindhoven (NL)

(21) Appl. No.: 11/664,224

(22) PCT Filed: Oct. 13, 2005
(86) PCT No.: PCT/IB05/53363

§ 371 Date: Mar. 29, 2007

(30) Foreign Application Priority Data
Oct. 22, 2004 (JP) 2004-307559

(51) Int. Cl. G06F 3/042

(52) U.S. Cl. 345/175; 382/124

(57) ABSTRACT

A display device which can authenticate fingerprint without a fingerprint sensor device and can be prevented from large size or reduced the size. A display device (1) is provided with a pixel or sub pixel comprising a photo diode (11) for detecting a light from a object, a holding capacitor (13) for holding a voltage (Vn1) corresponding to an intensity of the light detected by the photo diode (11), and a refreshing means (18) for writing a voltage (Vdd or Vss) into the holding capacitor (13) (node N1) on the basis of the voltage Vn1 held in the holding capacitor (13).

### TECHNICAL FIELD

The invention relates to a display device comprising a sub pixel or a pixel.

### BACKGROUND ART

In recent years, various data have been easily transmitted and received using a display device such as a mobile phone and a personal computer, as the Internet grows rapidly. There are many cases where data to be transmitted and to be received contain personal information. Therefore, if the third party saw the personal information stored in the mobile phone or the personal computer, the personal information might be abused. In order to prevent such abuse, for example, a method is used in which you can not use the display device unless a valid password is entered. However, if the password were seen by the third party, the personal information might be abused. Therefore, a fingerprint sensor device and a display device with a fingerprint sensor start to become widespread.

### DISCLOSURE OF INVENTION

### Technical Problem

However, a problem of the conventional display device with finger print sensor is that to provide with the fingerprint sensor hinders downsizing of the display device.

Further, a problem of the fingerprint sensor device is that not only the display device but also the fingerprint sensor device must be prepared since the fingerprint sensor device is used as a peripheral equipment for the display device.

It is an object of the invention to provide a display device which can perform a fingerprint verification without using a fingerprint sensor device and which can achieve prevention or reduction of its upsizing.

### Technical Solution

The present invention is a display device provided with a pixel or sub pixel comprising a light detecting means for detecting light from an object, a holding means for holding a first data corresponding to an intensity of said light detected by said light detecting means, and a refreshing means for writing a second data into said holding means on the basis of said first data held by said holding means.

According to the present invention, the first data corresponding to an intensity of said light detected by said light detecting means is held in the holding means, and the refreshing means writes the second data into said holding means on the basis of said first data on purpose. Therefore, the first data held in the holding means is prevented from changing to unintended data, a correct data related to the object can be obtained. The light from the object is, for example, light emitted from the object, light reflected by the object, and so on. The light detecting means, the holding means, and the refresh means are provided in the pixel or sub pixel, so that upsizing and complexity of the display device are prevented. The first data may be the same as the second data or may be different from the second data. The first and second data can be represented in the form of voltage, current, or the amount of charge.

### BRIEF DESCRIPTION OF DRAWINGS

FIG. 1 is one example of a cross-sectional view of a display device 1 according to one example of the present invention;

FIG. 2 is one example of a schematic diagram showing one of pixels of the display device 1 shown in FIG. 1, the pixels arranged in matrix pattern;

FIG. 3 is one example of a circuit diagram of one pixel in which a fingerprint data capturing part 20 shown in FIG. 2 is illustrated in detail;

FIG. 4 shows one example of timing diagrams (a) to (f) when the display device 1 captures data of the fingerprint 101 and transmits the captured data of fingerprint 101 to the processing circuit;

FIG. 5 is one example of a schematic diagram showing pixels of the display device 1 of second embodiment, the pixels arranged in matrix pattern;

FIG. 6 is one example of a circuit diagram of one pixel in which a fingerprint data capturing part 80 shown in FIG. 5 is illustrated in detail;

FIG. 7 is one example of a pattern of fingerprint 101 displayed on the display screen 55;

FIG. 8 shows one example of timing diagrams (a) to (i) for explaining the main operation OPmain;

FIG. 9 shows one example of timing diagrams (a) to (i) for explaining a main operation OPmain in a case where a voltage sampled during a sample period (sample) is smaller voltage Vlow than a threshold voltage Vth;

FIG. 10 shows a example of timing diagrams (a) to (i) for a case where a common electrode voltage Vcom alternating between Vss(=0V) and Vdd(=5V) is supplied to the common electrode Ecom;

FIG. 11 shows a example of timing diagrams (a) to (i) for a case where a common electrode voltage Vcom alternating between Vss(=0V) and Vdd(=5V) is supplied to the common electrode Ecom;

FIG. 12 shows an example of applying the display device 1 to a mobile phone 200; and

FIG. 13 shows an example of applying the display device 1 to a personal computer 300.

### BEST MODE FOR CARRYING OUT THE INVENTION

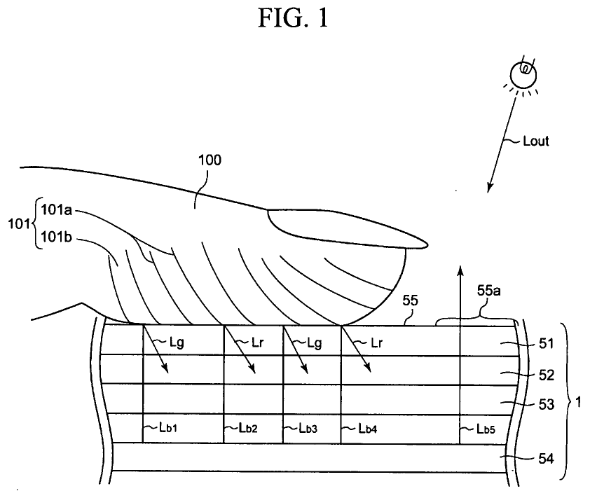

FIG. 1 is one example of a cross-sectional view of a display device 1 according to one example of the present invention.

The display device 1 comprises a first substrate 51 and a second substrate 53 facing each other and sandwiching a liquid crystal layer 52 therebetween. At the back of the second substrate 53, a backlight 54 is provided. Data of a fingerprint of a user having a right to use the display device 1 has been beforehand stored in the display device 1. The display device 1 has a fingerprint verification function of judging whether a fingerprint of a user matches with the fingerprint beforehand stored in the display device 1 in order that a user having no right to use can not use the display device 1 freely. If the fingerprints do not match with each other, the display device 1 stops operating, so that the user having no right to use can not use the display device 1 freely.

The display device 1 comprises a fingerprint verification starting button (not shown) for starting the fingerprint verification operation. On pressing the fingerprint verification starting button, the display device 1 starts the fingerprint verification operation. On the other hand, the user presses his finger 100 against a display screen 55 of the display device 1 as shown in FIG. 1 during the fingerprint verification operation of the display device 1 in order that the display device 1 can capture data of his fingerprint 101. It is described below how the display device 1 captures the data of his fingerprint 101.

On pressing the fingerprint verification starting button (not shown) described above, the backlight 54 emits light. In FIG. 1, five lights Lb1, Lb2, Lb3, Lb4, and Lb5 are representatively illustrated as light emitted from the backlight 54. Four lights Lb1 to Lb4 of five lights Lb1 to Lb5 reflect from the finger 101. The light Lb5 passes through a region 55a of the display screen 55, which is not covered with the finger 100, and then is emitted outside. Four lights Lb1 to Lb4 reflecting from the finger 100 enter into a liquid crystal layer 52 and travel toward the substrate 53 as reflected light Lr or Lg. The reflected light Lr is light reflecting from a ridge 101a of the finger 100 and the reflected light Lg is light reflecting from a groove 101b of the finger 100. The display device 1 performs a comparison whether the data of the fingerprint 101 of the finger 100 matches with the data of the fingerprint beforehand stored in the display device 1, by using intensities of the reflected lights Lr and Lg. If both data of fingerprints match with each other, the user can use the display device 1, but if not, the display device 1 stops operating, so that the use can not use the display device 1. The display device 1 comprises a fingerprint data capturing part in each pixel in order to capture the data of the fingerprint 101 by using the intensities of the reflected lights Lr and Lg. The structure of the pixel having the fingerprint data capturing part is described below.

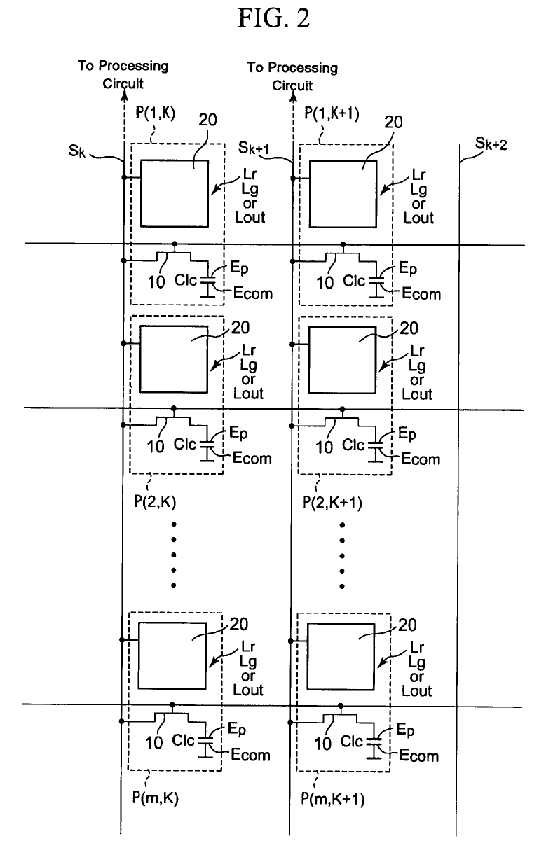

FIG. 2 is one example of a schematic diagram showing pixels of the display device 1 shown in FIG. 1, the pixels arranged in matrix pattern.

The display device 1 comprises the pixels arranged in m rows and n columns, and FIG. 2 representatively illustrates the pixels P(1, k), P(2, k), . . . , P(m, k) on the k column and the pixels P(1, k+1), P(2, k+1), . . . , P(m, k+1) on the k+1 column. Each pixel has liquid crystal capacitance Clc formed by a pixel electrode Ep and a common electrode Ecom and has a pixel switch 10 between a source line and the pixel electrode Ep. The pixel switch 10 is driven through a gate line. Further, each pixel has the fingerprint data capturing part 20 for capturing data related to the fingerprint 101 (see FIG. 1). The common electrode Ecom of elements shown in FIG. 2 is provided on the first substrate 51, but the other elements (such as the fingerprint data capturing part 20, the pixel switch 10, and the pixel electrode Ep) of elements shown in FIG. 2 are all provided on the second substrate 53.

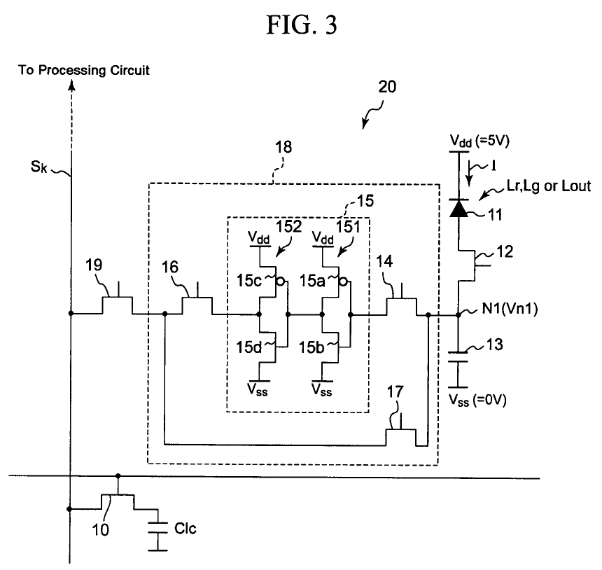

FIG. 3 is one example of a circuit diagram of one pixel in which a fingerprint data capturing part 20 shown in FIG. 2 is illustrated in detail.

The fingerprint data capturing part 20 comprises a photodiode 11. The diode 11 is connected to the power supply Vdd at its cathode and is connected to a sample switch 12 at its anode. The fingerprint data capturing part 20 has a hold capacitor 13 for accumulating an amount of charge corresponding to intensity of light received by the diode 11. The hold capacitor 13 is connected to the sample switch 12 at one end and is connected to the power supply Vss at the other end. The power supplies Vdd and Vss supply 5V and 0V, respectively, but may supply different voltages from 5V and 0V depending on the application purpose of the display device 1 etc.

Further, the fingerprint data capturing part 20 comprises a refresh means 18 for rewriting voltage to the node N1 between the sample switch 12 and the hold capacitor 13. The refresh means 18 comprises a first refresh switch 14, a refresh buffer 15, and a second and a third refresh switches 16 and 17, which are connected in loop shape. The refresh means 18 is detailed later. All pixels of the display device 1 comprise the fingerprint data capturing part 20 shown by the circuit diagram of FIG. 3. The display device 1 captures data of the fingerprint 101 by the fingerprint data capturing part 20 and transmits the captured data of fingerprint 101 to a processing circuit (not shown) through the source line in order to judge whether the fingerprint 101 matches with the fingerprint beforehand stored in the display device 1. Next, it will be described in detail how the display device 1 captures data of the fingerprint 101 and transmits the captured data of fingerprint 101 to the processing circuit.

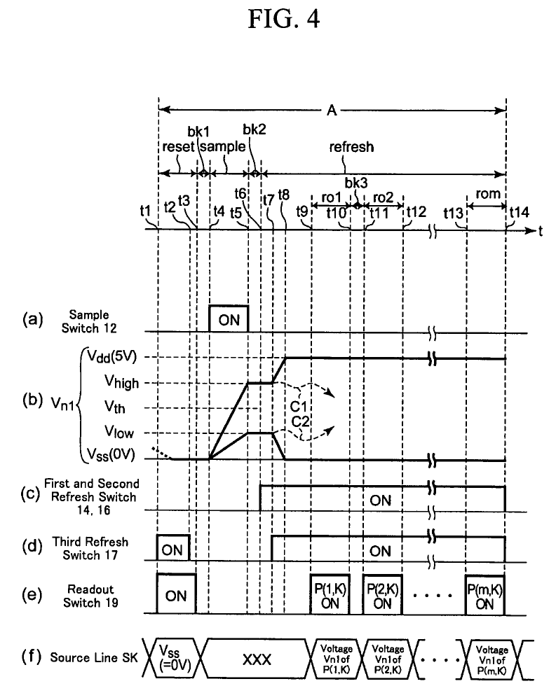

FIG. 4 shows one example of timing diagrams (a) to (f) when the display device 1 captures data of the fingerprint 101 and transmits the captured data of fingerprint 101 to the processing circuit. In the explanation of the timing charts, the operations of the pixels P(1, k), P(2, k), . . . , P(m, k) associated with the source line Sk are representatively taken up and explained, but the pixels associated with the other source lines operate in parallel with the pixels associated with the source line Sk and operate similarly to the pixels associated with the source line Sk

Capturing data of the fingerprint 101 and transmitting the captured data of fingerprint 101 to the processing circuit are performed during a period A. The period A has a reset period (reset), a blank period (bk1), a sample period (sample), a blank period (bk2), and a refresh period (refresh). On the user's pressing the fingerprint verification starting button, the reset period (reset) starts first.

The reset period (reset) is provided in order to set the voltage Vn1 on the node N1 (see FIG. 3) of each of the pixels P(1, k), P(2, k), . . . , P(m, k) to the Vss (=0V). For this purpose, at the starting instant t1 of the reset period (reset), readout switches 19 and third refresh switches 17 of the pixels P(1, k), P(2, k), . . . , P(m, k) are simultaneously changed from off-state to on-state (see (d) and (e) of FIG. 4). This electrically connects the nodes N1 to the source line Sk. The source line Sk is supplied with the voltage Vss (=0V) from the processing circuit (not shown), while the switches 19 and 17 are in the on-state (see (f) of FIG. 4). Therefore, the voltage Vss (=0V) on the source line Sk is supplied to the nodes N1 through the switches 19 and 17, so that the voltage Vn1 on the node N1 is reset to 0V during the reset period (reset) (see (b) of FIG. 4)

Since the sample switches 12 of the pixels P(1, k), P(2, k), . . . , P(m, k) are off-state during the reset period (reset) (see (a) of FIG. 4), the hold capacitors 13 are disconnected from the power supply Vdd. Therefore, the voltages Vn1 on the nodes N1 surely become 0V in the reset period (reset).

After the third refresh switch 17 and the readout switch 19 of each pixel are changed to on-state at the instant t1, the third refresh switches 17 are changed from on-state to off-state at the instant t2 and the readout switches 19 are changed from on-state to off-state at the instant t3 (see (d) and (e) of FIG. 4), and the reset period (reset) is completed at the instant t3. After the reset period (reset) is completed, a transition is made to the sample period (sample) via the blank period (bk1).

During the sample period (sample), it is performed that the diodes 11 of the pixels P(1, k), P(2, k), . . . , P(m, k) receive the reflected light Lr or Lg from the finger 100 and that the received reflected light Lr or Lg is converted into voltage on the basis of the intensity of the reflected light. In order that the diode 11 can receive the reflected light Lg or Lr from the finger 100, the liquid crystal layer 52 is adjusted to a state in which the layer 52 can transmit light (hereinafter, referred to as “light transmitting state”) at least during the sample period (sample). If the finger 100 is pressed against the display screen 55 as shown in FIG. 1, the reflected lights Lr and Lg from the finger 100 pass through the liquid crystal layer 52 on the condition that the liquid crystal layer 52 is in the light transmitting state, so that the diode 11 can receive the reflected light Lr or Lg. It is noted that, seeing FIG. 1, the display screen 55 has an area 55a which is not covered with the finger 100. Therefore, not only the reflected lights Lr and Lg but also outer light Lout passes through the liquid crystal layer 52 via the area 55a of the display screen 55, so that the diodes 11 located near the area 55a receive the outer light Lout instead of the reflected light Lr or Lg most effectively. As described above, depending on which part of the display screen 55 the finger 100 is pressed against, the diode 11 may receive the reflected light Lr or Lg most effectively or may receive the outer light Lout most effectively. It is noted that the sample switches 12 of the pixels P(1, k), P(2, k), . . . , P(m, k) are in the on-state during the sample period (from the instant t4 to the instant t5) (see (a) of FIG. 4). Therefore, if the diode 11 receives light, photo current 1 corresponding to the intensity of the light received by the diode 11 flows between the power supplies Vdd and Vss. Since the diode 11 may receive the reflected light Lr or Lg most effectively or may receive the outer light Lout most effectively depending on which part of the display screen 55 the finger 100 is pressed against, the photo current 1 corresponds to the intensity of the reflected light Lg, the reflected light Lr, or the outer light Lout.

If the diode 11 received the lights Lb1, Lb2, . . . directly from the backlight 54, the photo current 1 would not substantially affected by the reflected light Lg, the reflected light Lr or the outer light Lout, but would be strongly affected by the lights Lb1, Lb2, . . . from the backlight 54. The lights Lb1, Lb2, . . . from the backlight 54 are substantially uniform intensities. Therefore, if the diodes 11 of all pixels received the lights Lb1, Lb2, . . . directly from the backlight 54, the photo currents 1 of all pixels would be the substantially same, so that the photo current 1 corresponding to the reflected light Lg, the reflected light Lr, or the outer light Lout could not be generated. To circumvent such problem, a light shielding means (not shown) for preventing the diode 11 from directly receiving the light from the backlight 54 is provided under the diode 11. Each diode 11 is not substantially affected by the lights Lb1, Lb2, . . . from the backlight 54 thanks to the light shielding means, so that the photo current 1 corresponding to the intensity of the reflected light Lg, the reflected light Lr, or the outer light Lout can be generated.

If the photo current 1 flows, the voltage Vn1 on the node N1 is changed during the sample period (sample) from the Vss (=0V) to a voltage which depends on the intensity of the reflected light Lg, the reflected light Lr, or the outer light Lout. FIG. 4(b) shows two cases, one case where the voltage Vn1 on the node N1 is changed during the sample period (sample) from the Vss (=0V) to a voltage Vlow smaller than a threshold voltage Vth and the other case where the voltage Vn1 on the node N1 is changed during the sample period (sample) from the Vss (=0V) to a voltage Vhigh larger than the threshold voltage Vth. It is noted that the threshold voltage Vth is used as a yardstick indicating which light of the reflected lights Lr and Lg the diode 11 of each pixel receives most efficiently. In this embodiment, the threshold voltage Vth is defined in such a way that the voltage Vn1 becomes larger than or equal to the threshold voltage Vth at the ending instant t5 of the sample period (sample) if the diode 11 receives the reflected light Lr most efficiently, whereas the voltage Vn1 becomes smaller than the threshold voltage Vth at the ending instant t5 of the sample period (sample) if the diode 11 receives the reflected light Lg most efficiently. The threshold voltage Vth may be 2.5V for example. It is again noted that there is a case where the diode 11 receives the outer light Lout instead of the reflected light Lr or Lg most efficiently. If the outer light Lout is most efficiently received, both cases may be considered depending on the intensity of the outer light Lout: one case where the voltage Vn1 becomes larger than or equal to the threshold Vth and the other case where the voltage Vn1 becomes smaller than the threshold Vth. The following descriptions continue with the assumption that the fingerprint verification operation is performed in an environment where the intensity of the outer light Lout is weaker than the intensities of the reflected lights Lr and Lg. Therefore, if the diode 11 receives the outer light Lout most efficiently, the voltage Vn1 becomes smaller than the threshold voltage Vth at the ending instant t5 of the sample period (sample). From the above description, (1) if the voltage Vn1 on the node N1 is the Vhigh at the ending instant t5 of the sample period (sample), and (2) if the voltage Vn1 on the node N1 is the Vlow at the ending instant t5 of the sample period (sample), we can consider as follows.

(1) a case where the voltage Vn1 on the node N1 is the Vhigh

This means that the diode 11 receives the reflected light Lr most effectively, since the voltage Vhigh is larger than the threshold voltage Vth. Since the reflected light Lr is a reflected light from the ridge 101a of the fingerprint 101, the case where the diode 11 has most efficiently received the reflected light Lr means that the pixel has performed the sampling of data on the ridge 101a of the fingerprint 101.

(2) a case where the voltage Vn1 on the node N1 is the Vlow

This means that the diode 11 receives the reflected light Lg or the outer light Lout most effectively, since the voltage Vlow is smaller than the threshold voltage Vth. The case where the diode 11 has most efficiently received the reflected light Lg means that the pixel has performed the sampling of data on the groove 101b of the fingerprint 101, and the case where the diode 11 has most efficiently received the outer light Lout means that the pixel has performed the sampling of data unrelated to the fingerprint 101 (hereinafter, this data is referred to as “background data”).

In this way, during the sample period (sample), the reflected light Lg, the reflected light Lr, or the outer light Lout is converted into a voltage on the basis of the intensity of the light, and the voltage is temporarily written into the node N1.

After completing the sample period (sample), a transition is made to the refresh period (refresh) through the blank period (bk2).

During the refresh period (refresh), the refresh means 18 of each of the pixels P(1, k), P(2, k), . . . , P(m, k) rewrites the voltage Vdd (=5V) or Vss (=0V) into the node N1 on the basis of the voltage Vn1 of the ending instant t5 of the sample period (sample). Specifically, the refresh means 18 continues to rewrite the voltage Vdd (=5V) into the node N1 if the voltage Vn1 on the node N1 at the ending instant t5 of the sample period (sample) is larger than or equal to the threshold value Vth. On the other hand, the refresh means 18 continues to rewrite the voltage Vss (=0V) into the node N1 if the voltage Vn1 on the node N1 at the ending instant t5 of the sample period (sample) is smaller than the threshold value Vth. Below, two operations (1) and (2) are detailed in this order: (1) is operation during the refresh period (refresh) performed if the voltage Vn1 at the ending instant t5 of the sample period (sample) is the Vhigh (hereinafter, such operation is referred to as “first refresh operation OPhigh”), and (2) is operation during the refresh period (refresh) performed if the voltage Vn1 at the ending instant t5 of the sample period (sample) is the Vlow (hereinafter, such operation is referred to as “second refresh operation OPlow”).

(1) With respect to the first refresh operation OPhigh

In this case, the refresh means 18 operates so as to continue to rewrite the voltage Vdd (=5V) into the node N1. For the purpose of performing such rewriting operation, the first and second refresh switches 14 and 16 of each pixel are changed from off-state to on-state at the instant t6 (see (c) of FIG. 4) and the third refresh switch 17 of each pixel is changed from off-state to on-state at the instant t7 (see (d) of FIG. 4). Turning the first refresh switch 14 on, the node N1 is connected to the refresh buffer 15, so that the refresh buffer 15 receives the voltage Vn1 on the node N1.

The refresh buffer 15 comprises first and second inverters 151 and 152 connected to each other in series. The first inverter 151 comprises transistors 15a and 15b connected to each other in series and the second inverter 152 comprises transistors 15c and 15d connected to each other in series. If the first inverter 151 receives the voltage larger than or equal to the threshold voltage Vth from the node N1, the transistor 15a becomes off-state, but the transistor 15b becomes on-state, so that the first inverter 151 connects the power supply Vss (=0V) to the second inverter 152. In this case, the transistor 15d of the second inverter 152 becomes off-state, but the transistor 15c becomes on-state, so that the second inverter 152 connects the power supply Vdd (=5V) to the second refresh switch 16.

On the other hand, if the first inverter 151 receives the voltage smaller than the threshold voltage Vth from the node N1, the transistor 15b becomes off-state, but the transistor 15a becomes on-state, so that the first inverter 151 connects the power supply Vdd (=5V) to the second inverter 152. In this case, the transistor 15c of the second inverter 152 becomes off-state, but the transistor 15d becomes on-state, so that the second inverter 152 connects the power supply Vss (=0V) to the second refresh switch 16.

Since we now consider the case where the voltage Vn1 on the node N1 is the voltage Vhigh larger than or equal to the threshold voltage Vth, the first inverter 151 connects the power supply Vss (=0V) to the second inverter 152, so that the second inverter 152 connects the power supply Vdd (=5V) to the second refresh switch 16. Since the third refresh switch 17 is in the on-state after the instant t7 (see (d) of FIG. 4), the second inverter 152 connects the power supply Vdd (=5V) to the node N1 through the transistor 15c, the second and third refresh switches 16 and 17. As a result of this, the voltage Vn1 on the node N1 is changed from Vhigh to Vdd, so that the voltage Vdd instead of the voltage Vhigh is written into the node N1. FIG. 4 shows a situation in which the voltage Vn1 on the node N1 reaches from Vhigh to Vdd at the instant t8 (see (b) of FIG. 4). Since the first refresh switch 14 remains ON after the voltage Vn1 reaches the Vdd (see (c) of FIG. 4), the voltage Vn1 of the node N1 (=Vdd) is supplied to the refresh buffer 15 through the first refresh switch 14. Since the voltage Vdd received by the refresh buffer 15 is larger than the threshold voltage Vth, the node N1 is connected to the power supply Vdd (=5V) through the transistor 15c of the second inverter 152, the second and third refresh switches 16 and 17, so that the voltage Vn1 on the node N1 is kept Vdd. Since the voltage Vn1 on the node N1 is kept Vdd, the refresh means 18 continues to write the voltage Vdd into the node N1 as long as the first to the third refresh switches 14, 16 and 17 is in the on-state. Therefore, even if the voltage Vn1 on the node N1 changes a different value from Vdd because of, for example, a leak current, the voltage Vn1 on the node N1 immediately returns Vdd. In this way, the refresh means 18 continues to write Vdd into the node N1 during the refresh period (refresh).

(2) With respect to the second refresh operation OPlow

In this case, the refresh means 18 operates so as to continue to rewrite the voltage Vss (=0V) into the node N1. For the purpose of performing such rewriting operation, the first and second refresh switches 14 and 16 are changed from off-state to on-state at the instant t6 and the third refresh switch 17 is changed from off-state to on-state at the instant t7, just as in the case of the first refresh operation OPhigh described above. Turning the first refresh switch 14 on, the node N1 is connected to the refresh buffer 15, so that the refresh buffer 15 receives the voltage Vn1 on the node N1. Since the voltage Vn1 is the voltage Vlow smaller than the threshold voltage Vth, the first inverter 151 connects the power supply Vdd (=5V) to the second inverter 152, so that the second inverter 152 connects the power supply Vss (=0V) to the second refresh switch 16. Since the third refresh switch 17 is in the on-state after the instant t7 (see (d) of FIG. 4), the second inverter 152 connects the power supply Vss (=0V) to the node N1 through the transistor 15d, the second and third refresh switches 16 and 17. As a result of this, the voltage Vn1 on the node N1 is changed from Vlow to Vss, so that the voltage Vss instead of the voltage Vlow is written into the node N1. FIG. 4 shows a situation in which the voltage Vn1 on the node N1 reaches from Vlow to Vss (see (b) of FIG. 4). Since the first refresh switch 14 remains ON after the voltage Vn1 reaches the Vss (see (c) of FIG. 4), the voltage Vn1 of the node N1 (=Vss) is supplied to the refresh buffer 15 through the first refresh switch 14. Since the voltage Vss received by the refresh buffer 15 is smaller than the threshold voltage Vth, the node N1 is connected to the power supply Vss (=0V) through the transistor 15d of the second inverter 152, the second and third refresh switches 16 and 17, so that the voltage Vn1 on the node N1 is kept Vss. Since the voltage Vn1 on the node N1 is kept Vss, the refresh means 18 continues to write the voltage Vss into the node N1 as long as the first to the third refresh switches 14, 16 and 17 is in the on-state. Therefore, even if the voltage Vn1 on the node N1 changes a different value from Vss because of, for example, a leak current, the voltage Vn1 on the node N1 immediately returns Vss. In this way, the refresh means 18 continues to write Vss into the node N1 during the refresh period (refresh).

Since the refresh means 18 continues to write the voltage Vdd or Vss into the node N1 by performing the first or second refresh operation OPhigh or OPlow, the node N1 surely holds the voltage Vdd or Vss even if the leak current occurs. Therefore, the voltage Vdd or Vss can be correctly stored in the node N1. The display device 1 operates so as to supply the written voltage Vdd or Vss on the node N1 to the processing circuit (not shown) through the source line, while the refresh means 18 continues to write the voltage Vdd or Vss into the node N1. This operation is performed as follows.

Since the first to third refresh switches 14, 16 and 17 are in the on-state when the refresh means 18 is writing the voltage Vdd or Vss into the node N1, the node N1 can be connected to the processing circuit by turning the readout switch 19 on. However, if the pixels P(1, k), P(2, k), . . . , P(m, k) turned the readout switches 19 on simultaneously, the voltages on the nodes N1 of the pixel P(1, k), P(2, k), . . . , P(m, k) would collide with each other on the source line Sk, so that correct voltage values could not be supplied to the processing circuit. To overcome this problem, in the first embodiment, the readout switches 19 of the pixels P(1, k), P(2, k), . . . , P(m, k) are in turn set to on-state. More specifically, during the readout period (ro1) (the instant t9 to t10), the readout switch 19 of only pixel P(1, k) is turned on and the readout switches 19 of the other pixels P(2, k), . . . , P(m, k) are turned off as shown in (e) of FIG. 4. Therefore, the source line Sk is supplied with the voltage Vdd or Vss on the node N1 of only pixel P(1, k), so that the voltage Vdd or Vss on the node N1 of the pixel P(1, k) is correctly supplied to the processing circuit.

After completing the readout period (ro1), a transition is made to a readout period (ro2) via the bank period (bk3). During the readout period (ro2) (the instant t11 to t12), the readout switch 19 of only pixel P(2, k) is turned on and the readout switches 19 of the other pixels P(1, k), P(3, k), . . . , P(m, k) are turned off (see (e) of FIG. 4). Therefore, the voltage Vdd or Vss on the node N1 of only pixel P(2, k) is supplied to the processing circuit through the source line Sk. Similarly, the voltages on the nodes N1 of the P(3, k), . . . , P(m, k) are in turn supplied to the processing circuit through the source line Sk. The voltages Vdd or Vss are read out from the nodes N1 in order of the pixels P(1, k), P(2, k), . . . , P(m, k) in the above description, but this readout order may be any order.

In this way, the processing circuit receives the voltage Vdd or Vss from each pixel. If the processing circuit receives the voltage Vdd from a certain pixel, this means that the certain pixel has performed the sampling of the voltage Vhigh during the sample period (sample), i.e. the certain pixel has performed the sampling of data representing the ridge 101a of the fingerprint 101. On the other hand, if the processing circuit receives the voltage Vss from a certain pixel, this means that the certain pixel has performed the sampling of the voltage Vlow during the sample period (sample), i.e. the certain pixel has performed the sampling of data representing the groove 101b of the fingerprint 101 data or the sampling of background data unrelated to the fingerprint 101. Therefore, the voltage Vss dose not always mean the data of groove 101b of the fingerprint 101. If the processing circuit has received the voltage Vss, the processing circuit distinguishes whether the received voltage Vss means the data of groove 101b of the fingerprint 101 or the background data, on the basis of which pixel the received data Vss has been outputted from. More specifically, if the received data Vss has been outputted from a pixel which exists between pixels corresponding to the ridges 101a (i.e. between pixels outputting the voltages Vdd), the voltage Vss is recognized as the data of groove 101b of the finger print 101, and if not, the voltage Vss is recognized as the background data.

The processing circuit compares the received data of fingerprint 101 with the beforehand stored original data of fingerprint. If these fingerprint data are matched with each other, the fingerprint verification operation is completed, so that the display device 1 is shifted to a normal operation. If the display device 1 is shifted to the normal operation, the user can work the display device 1 by pressing control keys provided to the display device 1 itself or by remotely controlling the display device 1 with, e.g. the remote controller. On the other hand, if these fingerprint data are not matched with each other, the user can not work the display device 1 even if the user presses control keys of the display device 1 or the user remotely controls the display device 1 with the remote controller, so that the personal information can be protected form being learned by the third party.

The display device 1 of the first embodiment comprises the refresh means 18 in order to continue to write the voltage Vdd or Vss into the node N1. However, a case where the display device 1 dose not comprise the refresh means 18 will be described below in order to explain the advantage of the display device 1 comprising the refresh means 18.

If the display device 1 did not comprise the refresh means 18, the display device 1 could not continue to write the voltage Vdd or Vss into the node N1 during the refresh period (refresh). Therefore, the voltage Vhigh or Vlow temporarily written into the node N1 at the instant t5 might be changed to an unexpected voltage with the passage of time because of the leak current and so on (In (b) of FIG. 4, situations in which the voltages Vhigh and Vlow are changed are schematically shown by broken lines C1 and C2, respectively). In the case of such change in voltage, most undesired thing is as follows: although, for example, the voltage Vhigh is written into the node N1 at the instant t5, the voltage on the node N1 is changed from the voltage Vhigh to the voltage Vlow with the passage of time. If such change in voltage occurred, this would mean that the voltage Vhigh originally representing the ridge 101a of the fingerprint 101 is changed to the voltage Vlow representing the data of groove 101b of the fingerprint 101, so that correct data of the fingerprint 101 could not be transmitted to the processing circuit.

However, the first embodiment comprises the refresh means 18, so that the voltage Vhigh representing the ridge 101a of the fingerprint 101 continues to be written into the node N1 as the voltage Vdd, and the voltage Vlow representing data of the groove 101b of the fingerprint 101 continues to be written into the node N1 as the voltage Vss. Therefore, the voltage on the node N1 is prevented from being changed to the unexpected voltage, so that the correct data of the fingerprint 101 is transmitted to the processing circuit.

In the display device 1, during the sample period (sample), the pixels P(1, k), P(2, k), . . . , P(m, k) simultaneously perform the operation of temporarily writing the voltage Vhigh or Vlow into the node N1. Therefore, the pixels P(1, k), P(2, k), . . . , P(m, k) need not in turn perform the operation of temporarily writing the voltage Vhigh or Vlow into the node N1, so that the fingerprint verification operation can be performed in a shorter time.

The display device 1 of the first embodiment can capture data of the whole fingerprint 101 by pressing the finger 100 against the display screen 55 without sliding the finger 100 on the display screen 55. Therefore, what the user must do in order for the display device 1 to capture the data of the fingerprint 101 can be simplified, so that user-friendly display device 1 is constructed.

Since the display device 1 of the first embodiment comprises the fingerprint data capturing part 20 in each pixel, the fingerprint verification can be performed without connecting a fingerprint device to the display device 1 as the peripheral device of the display device 1. Further, since the display device 1 of the first embodiment comprises the fingerprint data capturing part 20 in each pixel, the upsizing of the display device can be prevented or reduced as compared with the conventional display device comprising the fingerprint sensor outside the display screen. For example, if the display device 1 is a transflective type or a visible everywhere transflective type, such fingerprint data capturing part 20 can be formed below the pixel electrode of each pixel, so that the fingerprint data capturing part 20 can be provided in each pixel without widening the area of each pixel. Therefore, the upsizing of the display device can be prevented or reduced.

The operation of capturing data of the fingerprint 101 and transmitting it to the processing circuit is performed only one time in the display device 1 of the first embodiment. However, such operation may be performed two or more times to acquire two or more fingerprint data, and then a fingerprint data obtained by averaging such two or more fingerprint data may be compared with the original data of the fingerprint.

In the case of the display device of the first embodiment, all pixels comprise the fingerprint data capturing part 20. However, it is not always necessary for all pixels to have the fingerprint data capturing part 20 in so far as it is correctly recognized whether the data of fingerprint received by the processing circuit is identical with the original data of the fingerprint. However, it is desirable that the pixel likely to be covered with the finger 101 comprises the fingerprint data capturing part 20 as much as possible, since accuracy of the fingerprint data becomes higher as the number of pixels having the fingerprint data capturing part 20 increases.

The display device 1 of the first embodiment reads out the voltage Vdd or Vss from the node N1 of each of m pixels P(1, k), P(2, k), . . . , P(m, k) in turn during the refresh period (refresh). Therefore, the refresh means 18 of m-1 pixels P(1, k), P(2, k), . . . , P(m−1, k) other than the pixel P(m, k) continue to write the voltage Vdd or Vss into the node N1 even after the voltage Vdd or Vss has been read out from the node N1 (see FIG. 4). However, after the voltage Vdd or Vss has been read out from the node N1, the voltage Vdd or Vss does not have to be written into the node N1.

The display device 1 of the first embodiment has the blank periods (bk1, bk2, bk3, . . . ) within the period A, but the blank periods may be omitted is so far as the correct data of the fingerprint 101 is outputted to the processing circuit.

The fingerprint data capturing part 20 captures the fingerprint data without using the pixel switch 10 and the liquid crystal capacitance Clc in the first embodiment, but according to the invention, the fingerprint data can be captured using the pixel switch 10 and the liquid crystal capacitance Clc. An example of capturing the fingerprint data by using the pixel switch 10 and the liquid crystal capacitance Clc will be described below.

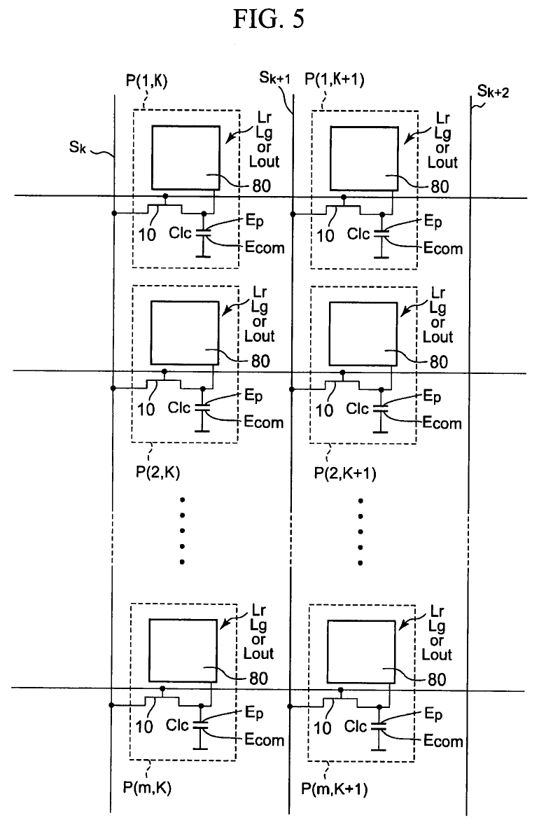

FIGS. 5 to 11 are illustrations of a display device 1 of a second embodiment which captures the fingerprint data using the pixel switch 10 and the liquid crystal capacitance Clc.

FIG. 5 is one example of a schematic diagram showing pixels of the display device 1 of second embodiment, the pixels arranged in matrix pattern.

Each pixel has a pixel switch 10, liquid crystal capacitance Clc, and a fingerprint data capturing part 80. In the second embodiment, the fingerprint data capturing part 80 is connected to the pixel switch 10 and the liquid crystal capacitance Clc instead of the source line, which is different manner from the first embodiment.

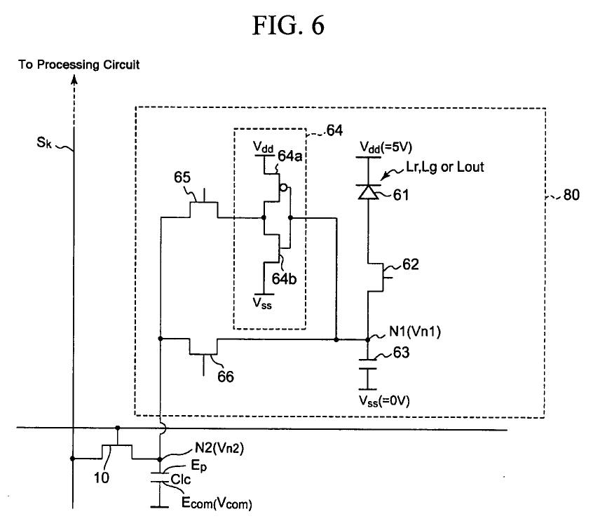

FIG. 6 is one example of a circuit diagram of one pixel in which a fingerprint data capturing part 80 shown in FIG. 5 is illustrated in detail.

The fingerprint data capturing part 80 comprises a photodiode 61. The diode 61 is connected to the power supply Vdd at its cathode and is connected to a sample switch 62 at its anode. The fingerprint data capturing part 80 has a hold capacitor 63 for accumulating an amount of charge corresponding to intensity of light received by the diode 61. The hold capacitor 63 is connected to the sample switch 62 at one end and is connected to the power supply Vss at the other end. The power supplies Vdd and Vss supply 5V and 0V, respectively, but may supply different voltages from 5V and 0V depending on the application purpose of the display device 1 etc.

Further, the fingerprint data capturing part 80 comprises a refresh inverter 64 having transistors 64a and 64b connected to each other in series. The refresh inverter 64 is connected to the node N1 at an input portion of the inverter 64 and is connected to a first refresh switch 65 at an output portion of the inverter 64. The first refresh switch 65 is connected to a second refresh switch 66, and the second refresh switch 66 is connected to the node N1. The first and second refresh switches 65 and 66 are connected to the liquid crystal capacitance Clc. In the second embodiment, each of all pixels comprises a fingerprint data capturing part 80 shown in the circuit diagram of FIG. 6. In the second embodiment, such fingerprint data capturing part 80 is used to capture data of the fingerprint 101 and transmit the captured data of the fingerprint 101 to the processing circuit in the different manner from the first embodiment. This method will be detailed later.

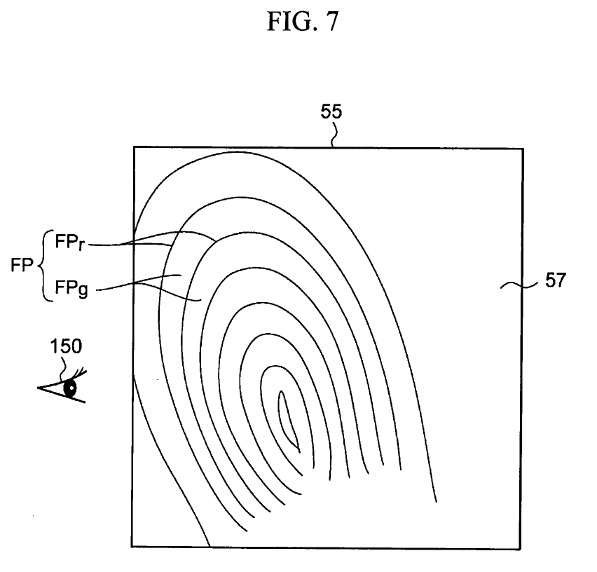

Further, in the second embodiment, in order to visually inform the user whether the display device 1 have captured the data of the fingerprint 101, a function is additionally provided which displays a pattern of the fingerprint 101 on the display screen 55 when the display device 1 have captured the data of the fingerprint 101 (see FIG. 7).

FIG. 7 is one example of a pattern of fingerprint 101 displayed on the display screen 55.

The display screen 55 displays a pattern FP of the fingerprint 101 in a background 57. The pattern FP of the fingerprint 101 consists of a pattern FPr of the ridge 10la and a pattern FPg of the groove 101b. The pattern FPr of the ridge 101a is displayed in black, and the background 57 and the pattern FPg of the groove 101b are displayed in white. If the display device 55 displays the pattern FP of the fingerprint 101 as shown in FIG. 7, the user 150 can visually realize through the display screen 55 that the display device 1 have captured the data of the fingerprint 101, so that a user-friendly fingerprint verification system is configured.

As described above, the display device 1 of the second embodiment performs not only the operation of capturing the data of the fingerprint 101 and transmitting the captured data of the fingerprint 101 to the processing circuit (hereinafter referred to as “a main operation OPmain”) but also the operation of displaying the pattern FP of the fingerprint 101 on the display screen 55 (hereinafter referred to as “a display operation OPdisplay”). For convenience in explanation, only the main operation OPmain will be first explained, and then both the main operation OPmain and the display operation OPdisplay will be explained.

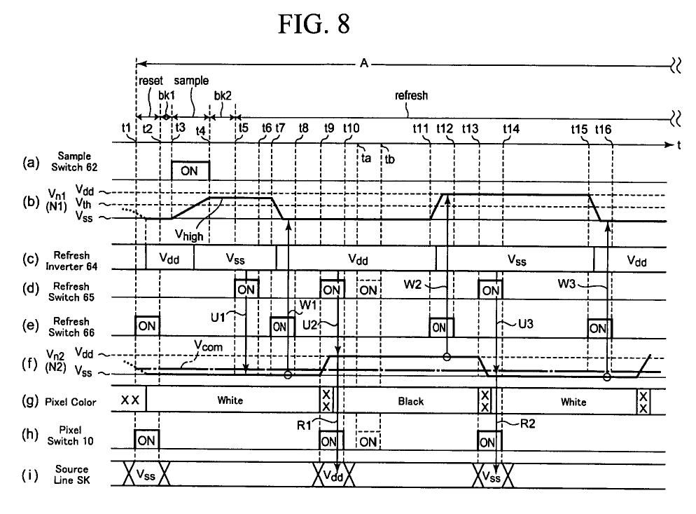

FIG. 8 shows one example of timing diagrams (a) to (i) for explaining the main operation OPmain. In the explanation of the timing charts, the operations of the pixels P(1, k), P(2, k), . . . , P(m, k) associated with the source line Sk are representatively taken up and explained, but the pixels associated with the other source lines can be similarly explained.

This main operation OPmain is performed during a period A shown in FIG. 8. The period A comprises a reset period (reset), a blank period (bk1), a sample period (sample), a blank period (bk2), and a refresh period (refresh) just as in the case of the first embodiment (see FIG. 4). When the user has pressed a fingerprint verification starting button of the display device 1, the reset period (reset) starts first.

The reset period (reset) is provided for the purpose of setting the voltage Vn1 on the node N1 (see FIG. 6) of each of the pixels P(1, k), P(2, k), . . . , P(m, k) to the Vss (=0V) just as in the case of the first embodiment. For this purpose, at the starting instant t1 of the reset period (reset), pixel switches 10 and second refresh switches 66 of the pixels P(1, k), P(2, k), . . . , P(m, k) are simultaneously changed from off-state to on-state (see (e) and (h) of FIG. 8). This electrically connects the nodes N1 to the source line Sk. The source line Sk is supplied with the voltage Vss (=0V) from the processing circuit (not shown), while the switches 10 and 66 are in the on-state (see (i) of FIG. 8). Therefore, the voltage Vss (=0V) on the source line Sk is supplied to the nodes N1 through the switches 10 and 66, so that the voltages Vn1 on the nodes N1 are reset to 0V during the reset period (reset) (see (b) of FIG. 8).

Since the sample switches 62 of the pixels P(1, k), P(2, k), . . . , P(m, k) are off-state during the reset period (reset) (see (a) of FIG. 8), the hold capacitors 63 are disconnected from the power supply Vdd. Therefore, the voltages Vn1 on the nodes N1 surely become 0V in the reset period (reset).

After the pixel switch 10 and the second refresh switch 66 of each pixel are changed to on-state at the instant t1, the pixel switches 10 and the second refresh switches 66 are changed from on-state to off-state at the instant t2 (see (e) and (h) of FIG. 8), so that the reset period (reset) is completed. After the reset period (reset) is completed, a transition is made to the sample period (sample) through the blank period (bk1).

During the sample period (sample), it is performed that the diodes 61 of the pixels P(1, k), P(2, k), . . . , P(m, k) receive the reflected light Lr or Lg from the finger 100 and that the received reflected light Lr or Lg is converted into voltage on the basis of the intensity of the reflected light. In order that the diode 61 can receive the reflected light Lg or Lr from the finger 100, the liquid crystal layer 52 is required to be adjusted to a light transmitting state at least during the sample period (sample) just as in the case of the first embodiment. Whether the liquid crystal layer 52 becomes the light transmitting state or not depends on the voltages on the pixel electrodes Ep and the voltage on the common electrode Ecom. A (f) of FIG. 8 illustrates the voltages Vn2 (solid line) on the pixel electrodes Ep (the nodes N2) and the voltage Vcom (chain line) on the common electrode Ecom. The voltage Vn2 on the pixel electrode Ep is the Vss (=0V) during the sample period (sample). Therefore, if the liquid crystal layer 52 is the normally white type, the liquid crystal layer 52 can be adjusted to the light transmitting state at least during the sample period (sample) by setting the voltage Vcom on the common electrode Ecom to e.g. Vss (=0V) at least during the sample period (sample). On the other hand, if the liquid crystal layer 52 is the normally black, the liquid crystal layer 52 can be adjusted to the light transmitting state at least during the sample period (sample) by setting the voltage Vcom on the common electrode Ecom to e.g. Vdd (=5V). The following descriptions continue, assuming that the liquid crystal layer 52 is the normally white. Therefore, in order to set the liquid crystal layer 52 to the light transmitting state at least during the sample period (sample), the voltage Vcom on the common electrode Ecom (the voltage Vcom is below referred to as “common electrode voltage Vcom”) may be set to e.g. Vss at least during the sample period (sample). In order to adjust the liquid crystal layer 52 to the light transmitting state during at least sample period (sample), a case where the common electrode voltage Vcom is a constant voltage Vss over the period A (the chain line shown in (f) of FIG. 8) is first discussed. In (f) of FIG. 8, a waveform of the voltage Vcom is slightly displaced from a line of the voltage Vss (=0V) for the purpose of making the waveforms of the voltages Vn2 and Vcom visible.

During the sample period (sample), the liquid crystal layer 52 is in the light transmitting state, so that pixel color is white (see (g) of FIG. 8).

During the sample period (sample) (the instant t3 to the instant t4), the sample switches 62 of the pixels P(1, k), P(2, k), . . . , P(m, k) are in the on-state (see (a) of FIG. 8). Therefore, if the diode 61 receives light, a photo current 1 corresponding to the intensity of the light received by the diode 61 flows between the power supplies Vdd and Vss. In the second embodiment, it is noted that the diode 61 may receive the reflected light Lr or Lg most effectively or may receive the outer light Lout most effectively depending on which part of the display screen 55 the finger 100 is pressed against, just as in the case of the first embodiment. Therefore, the photo current 1 corresponds to the intensity of the reflected light Lg, the reflected light Lr, or the outer light Lout. In order to generate the photo current 1 corresponding to the intensity of the reflected light Lg, the reflected light Lr, or the outer light Lout, a light shielding means (not shown) for preventing the diode 61 from directly receiving the light from the backlight 54 is provided under the diode 61. On flowing the photo current 1, the voltage Vn1 on the node N1 is changed from the Vss (=0V) to the voltage which depends on the intensity of the reflected light Lg, the reflected light Lr, or the outer light Lout. In this way, the intensity of the reflected light Lg, the reflected light Lr, or the outer light Lout is converted into a voltage, and this voltage is temporarily written into the node N1 (see (b) of FIG. 8). FIG. 8 shows a situation in which the voltage Vn1 on the node N1 is the voltage Vhigh larger than the threshold voltage Vth at the ending instant t4 of the sample period (sample). Like the threshold voltage Vth shown in FIG. 4, the threshold voltage Vth shown in FIG. 8 is used as a yardstick indicating which light of the reflected light Lr, the reflected light Lg and the outer light Lout the diode 61 of each pixel receives most efficiently. In the second embodiment, if the voltage Vn1 is smaller than the threshold voltage Vth, this means that the reflected light Lg or the outer light Lout is received most effectively, and if the voltage Vn1 is larger than or equal to the threshold voltage Vth, this means that the reflected light Lr is received most effectively, just as in the case of the first embodiment. In FIG. 8, since the voltage Vn1 on the node N1 reaches the voltage Vhigh larger than the threshold voltage Vth, the diode 61 receives the reflected light Lr most effectively.

After completing the sample period (sample), a transition is made to the refresh period (refresh) through the blank period (bk2).

In the second embodiment, during the refresh period (refresh), the voltage is written into the node N1 of each of the pixels P(1, k), P(2, k), . . . , P(m, k) and each pixel supplies the voltage to the processing circuit, just as in the case of the first embodiment. It is however noted that the writing of the voltage into the node N1 in the second embodiment is performed in the different manner from the first embodiment. In the first embodiment, the voltage Vdd or Vss continues to be written into the node N1 during the refresh period (refresh), but in the second embodiment, the voltages Vdd and Vss are alternately written into the node N1. More specifically, the voltages Vdd and Vss are alternately written into the node N1 as follows.

The voltage Vhigh temporarily stored into the node N1 at the ending instance t4 of the sample period (sample) is supplied to a refresh inverter 64. The refresh inverter 64 comprises transistors 64a and 64b connected to each other in series. If the voltage supplied to the refresh inverter 64 is larger than or equal to the threshold voltage Vth, the transistor 64a becomes off-state, but the transistor 64b becomes on-state, so that the refresh inverter 64 connects the power supply Vss (=0V) to the first refresh switch 65. On the other hand, if the voltage supplied to the refresh inverter 64 is smaller than the threshold voltage Vth (=2.5V), the transistor 64b becomes off-state, but the transistor 64a becomes on-state, so that the refresh inverter 64 connects the power supply Vdd (=5V) to the first refresh switch 65. In (c) of FIG. 8, a symbol “Vss” is described when the refresh inverter 64 is connecting the power supply Vss to the first refresh switch 65, and a symbol “Vdd” is described when the refresh inverter 64 is connecting the power supply Vdd to the first refresh switch 65. In FIG. 8, the refresh inverter 64 receives the voltage Vhigh, so that the inverter 64 connects the power supply Vss (=0V) to the first refresh switch 65.

The first refresh switch 65 of each pixel is in the on-state during the period from the instant t5 to the instant t6 (see (d) of FIG. 8). Therefore, during the period from the instant t5 to the instant t6, the power supply Vss (=0V) is connected to the liquid crystal capacitance Clc (node N2) through the first refresh switch 65, so that the voltage Vss is written into the node N2 (see (f) of FIG. 8). This is shown by an arrow U1 in FIG. 8.

Next, the written voltage Vss on the node N2 is written into the node N1. To achieve this operation, the second refresh switch 66 becomes on-state during the period from the instant t7 to the instant t8 (see (e) of FIG. 8). If the second refresh switch 66 becomes on-state, the written voltage Vss on the node N2 is supplied to the node N1 through the second refresh switch 66. This is shown by an arrow W1 in FIG. 8. As a result of this, the voltage Vn1 on the node N1 changes from Vhigh to Vss during the period from the instant t7 to the instant t8 (see (b) of FIG. 8). In this way, the voltage Vss is written into the node N1.

Further, in order to prevent the written voltage Vss on the node N1 from changing to an unintended voltage because of occurrence of the leak current etc, the fingerprint data capturing part 80 writes the voltage into the node N1 periodically after the instant t8. However, in the second embodiment, the voltage Vss dose not continue to be written into the node N1, but the voltages Vdd and Vss are alternately written into the node N1, which is different manner from the first embodiment. In order to alternately write the voltages Vdd and Vss, the fingerprint data capturing part 80 operates as follows.

Since the voltage Vss (=0V) is written into the node N1 during the period from the instant t7 to the instant t8, the refresh inverter 64 receives the voltage Vss. As a result of this, the refresh inverter 64 connects the power supply Vdd (=5V) instead of the power supply Vss (=0V) to the first refresh switch 65 (see (c) of FIG. 8). After that, the first refresh switch 65 is in the on-state during the period from the instant t9 to the instant t10 (see (d) of FIG. 8). Therefore, the refresh inverter 64 connects the power supply Vdd to the liquid crystal capacitance Clc (node N2) through the first refresh switch 65, so that the node N2 is supplied with the voltage Vdd. This is shown by an arrow U2 in FIG. 8. As a result of this, the voltage Vn2 on the node N2 changes from the voltage Vss to Vdd during the period from the instant t9 to the instant t10 (see (f) of FIG. 8). In this way, the voltage Vdd (=5V) is written into the node N2. And then, in order for the written voltage Vdd on the node N2 to be written into the node N1, the second refresh switch 66 becomes on-state during the period from the instant t11 to the instant t12 (see (e) of FIG. 8). If the second refresh switch 66 becomes on-state, the written voltage Vdd on the node N2 is supplied to the node N1 through the second refresh switch 66. This is shown by an arrow W2 in FIG. 8. As a result of this, the voltage Vn1 on the node N1 changes from Vss to Vdd during the period from the instant t11 to the instant t12 (see (b) of FIG. 8). In this way, the voltage Vdd is written into the node N1.

Since the voltage Vdd (=5V) is written into the node N1 during the period from the instant t11 to the instant t12, the refresh inverter 64 receives the voltage Vdd. As a result of this, the refresh inverter 64 connects the power supply Vss (=0V) instead of the power supply Vdd (=5V) to the first refresh switch 65 (see (c) of FIG. 8). After that, the first refresh switch 65 becomes on-state during the period from the instant t13 to the instant t14 (see (d) of FIG. 8). Therefore, the refresh inverter 64 connects the power supply Vss to the liquid crystal capacitance Clc (node N2) through the first refresh switch 65, so that the node N2 is supplied with the voltage Vss. This is shown by an arrow U3 in FIG. 8. As a result of this, the voltage Vn2 on the node N2 changes from the voltage Vdd to Vss during the period from the instant t13 to the instant t14 (see (f) of FIG. 8). In this way, the voltage Vss (=0V) is written into the node N2. And then, in order for the written voltage Vss on the node N2 to be written into the node N1, the second refresh switch 66 becomes on-state during the period from the instant t15 to the instant t16 (see (e) of FIG. 8). If the second refresh switch 66 becomes on-state, the written voltage Vss on the node N2 is supplied to the node N1 through the second refresh switch 66. This is shown by an arrow W3 in FIG. 8. As a result of this, the voltage Vn1 on the node N1 changes from Vdd to Vss during the period from the instant t15 to the instant t16 (see (b) of FIG. 8). In this way, the voltage Vss is written into the node N1.

Subsequently, in the similar way, the first and second refresh switches 65 and 66 become on-state alternately, so that the voltages Vss (=0V) and Vdd (=5V) are alternately written into the node N1 during the refresh period (refresh).

Further, in the second embodiment, while the voltages Vss (=0V) and Vdd (=5V) are alternately being written into the node N1, the voltage Vss or Vdd is supplied to the processing circuit. There are two ways of supplying the voltage Vss or Vdd to the processing circuit. One way is to make the pixel switch 10 and the second refresh switch 66 on-state, and the other way is to make the pixel switch 10 and the first refresh switch 65 on-state. The former way outputs the written voltage itself of the node N1 to the processing circuit, but the latter way inverts the written voltage of the node N1 through the refresh inverter 64 and outputs the inverted voltage to the processing circuit. Either way can output the voltage Vss or Vdd to the processing circuit. The former way must output the voltage Vss or Vdd to the processing circuit with the help of the charge ability of the capacitor 63, but the latter way outputs the voltage Vss or Vdd to the processing circuit with the help of the charge ability of the power supply Vss or power supply Vdd, so that the latter way with higher charge ability is preferable. For this reason, in the second embodiment, the voltage Vss or Vdd is outputted by the latter way to the processing circuit. Referring to FIG. 8 again, the first refresh switch 65 is in the on-state e.g. during the period from the instant t9 to the instant t10 (see (d) of FIG. 8). Therefore, by making the pixel switch 10 on-state during the period from the instant t9 to the instant t10 (see (h) of FIG. 8), the voltage Vss on the node N1 is supplied as the inverted voltage, Vdd, to the processing circuit through the source line Sk. This is shown by the arrow U2 and an arrow R1 in FIG. 8. If the processing circuit receives the voltage Vdd from the pixel, the processing circuit can recognize that the pixel has performed the sampling of the voltage Vhigh during the sample period (sample), i.e., the pixel has performed the sampling of the data corresponding to the ridge 101a of the finger 100. It is noted that since the first refresh switch 65 is in the on-state during the period from the instant t13 to the instant t14 (see (d) of FIG. 8), the pixel switch 10 may be made on-state during the period from the instant t13 to the instant t14 instead of the period form the instant t9 to the instant t10 (see (h) of FIG. 8). However, since the voltage on the node N1 during the period from the instant t13 to the instant t14 is Vdd (see (b) of FIG. 8), the inverted voltage, Vss, is supplied to the processing circuit through the source line Sk. This is shown by the arrow U3 and an arrow R2 in FIG. 8. Therefore, depending on when the pixel switch 10 is made on-state, the voltage Vdd and/or the voltage Vss can be supplied to the processing circuit.

However, if periods of the pixels P(1, k), P(2, k), . . . , P(m, k) overlapped one another during each of which both the first refresh switch 65 and the pixel switch 10 are in the on-state, the voltages outputted from the pixels P(1, k), P(2, k), . . . , P(m, k) would collide with one another on the source line Sk, so that the correct voltage value could not be supplied to the processing circuit. Therefore, periods of the pixels P(1, k), P(2, k), . . . , P(m, k) are required not to overlap one another during each of which both the first refresh switch 65 and the pixel switch 10 are in the on-state. For example, if the pixel P(1, k) keeps its first refresh switch 65 and its pixel switch 10 on-state during the period from the instant t9 to the instant t10, the pixel P(2, k) keeps its first refresh switch 65 and its pixel switch 10 on-state e.g. during the period from an instant ta to an instant tb. If the periods of the pixels P(1, k), P(2, k), . . . , P(m, k) are set so as not to overlap during each of which both the first refresh switch 65 and the pixel switch 10 are in the on-state, the processing circuit can be supplied with the correct voltage values.

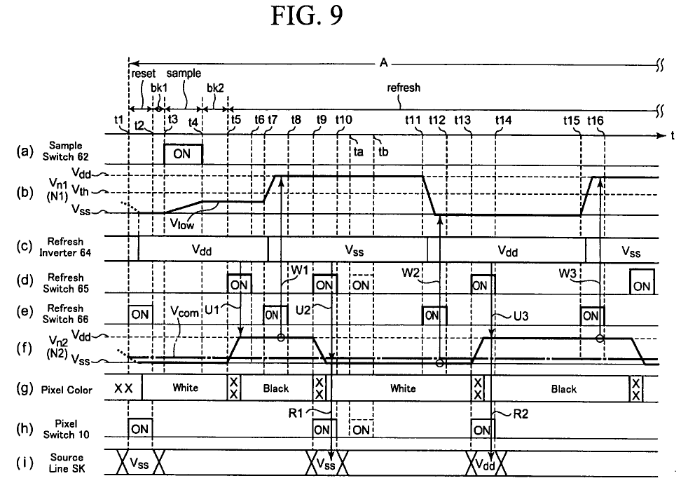

FIG. 8 illustrates the timing chart of a case where the voltage sampled during the sample period (sample) is larger than the threshold voltage Vth. Next, a timing chart of a case, where the voltage sampled during the sample period (sample) is smaller than the threshold voltage Vth, will be explained referring to FIG. 9.

FIG. 9 shows one example of timing diagrams (a) to (i) for explaining a main operation OPmain in a case where a voltage sampled during a sample period (sample) is smaller voltage Vlow than a threshold voltage Vth. In FIG. 9, the sample switch 62, the first and second refresh switches 65 and 66, and the pixel switch 10 are changed on and off at the same instants as FIG. 8.

Since the voltage sampled during the sample period (sample) is Vlow (see (b) of FIG. 9), the voltage Vlow is supplied to the refresh inverter 64, so that the refresh inverter 64 connects the power supply Vdd to the first refresh switch 65 (see (c) of FIG. 9) Since the first refresh switch 65 is in the on-state during the period from the instant t5 to the instant t6 (see (d) of FIG. 9), the refresh inverter 64 connects the power supply Vdd (=5V) to the liquid crystal capacitance Clc (node N2) through the first refresh switch 65, so that the voltage Vdd is supplied to the node N2. This is shown by an arrow U1 in FIG. 9. As a result of this, the voltage Vn2 on the node N2 changes from Vss (=0V) to Vdd, so that the voltage Vdd is written into the node N2 (see (f) of FIG. 9).

Next, in order for the written voltage Vss on the node N2 to be written into the node N1, the second refresh switch 66 becomes on-state during the period from the instant t7 to the instant t8 (see (e) of FIG. 9). If the second refresh switch 66 becomes on-state, the written voltage Vss on the node N2 is supplied to the node N1 through the second refresh switch 66. This is shown by an arrow W1 in FIG. 9. As a result of this, the voltage Vn1 on the node N1 changes from Vlow to Vdd during the period from the instant t7 to the instant t8 (see (b) of FIG. 9). In this way, the voltage Vdd is written into the node N1. Comparing FIGS. 8 and 9, it is understood that in FIG. 8, the voltage Vss (=0V) is written into the node N1 during the period from the instant t7 to the instant t8, but in FIG. 9, the voltage Vdd (=5V) is written into the node N1 during the period from the instant t7 to the instant t8.

In the case of FIG. 9, since the voltage Vdd (=5V) is written into the node N1 during the period from the instant t7 to the instant t8, the refresh inverter 64 receives the voltage Vdd. As a result of this, the refresh inverter 64 connects the power supply Vss (=0V) instead of the power supply Vdd (=5V) to the first refresh switch 65 (see (c) of FIG. 9). After that, the first refresh switch 65 is in the on-state during the period from the instant t9 to the instant t10 (see (d) of FIG. 9). Therefore, the refresh inverter 64 connects the power supply Vss to the liquid crystal capacitance Clc (node N2) through the first refresh switch 65, so that the node N2 is supplied with the voltage Vss. This is shown by an arrow U2 in FIG. 9. As a result of this, the voltage Vn2 on the node N2 changes from the voltage Vdd to Vss during the period from the instant t9 to the instant t10 (see (f) of FIG. 9). In this way, the voltage Vss (=0V) is written into the node N2. And then, in order for the written voltage Vss on the node N2 to be written into the node N1, the second refresh switch 66 becomes on-state during the period from the instant t11 to the instant t12 (see (e) of FIG. 9). If the second refresh switch 66 becomes on-state, the written voltage Vss on the node N2 is supplied to the node N1 through the second refresh switch 66. This is shown by an arrow W2 in FIG. 9. As a result of this, the voltage Vn1 on the node N1 changes from Vdd to Vss during the period from the instant t11 to the instant t12 (see (b) of FIG. 9). In this way, the voltage Vss is written into the node N1. Comparing FIG. 8 with FIG. 9, it is understood that in FIG. 8, the voltage Vdd (=5V) is written into the node N1 during the period from the instant t11 to the instant t12, but in FIG. 9, the voltage Vss (=0V) is written into the node N1 during the period from the instant t11 to the instant t12.

Since the voltage Vss (=0V) is written into the node N1, the refresh inverter 64 receives the voltage Vss. As a result of this, the refresh inverter 64 connects the power supply Vdd (=5V) instead of the power supply Vss (=0V) to the first refresh switch 65 (see (c) of FIG. 9). After that, the first refresh switch 65 becomes on-state during the period from the instant t13 to the instant t14 (see (d) of FIG. 9). Therefore, the refresh inverter 64 connects the power supply Vdd to the liquid crystal capacitance Clc (node N2) through the first refresh switch 65, so that the node N2 is supplied with the voltage Vdd. This is shown by an arrow U3 in FIG. 9. As a result of this, the voltage Vn2 on the node N2 changes from the voltage Vss to Vdd during the period from the instant t13 to the instant t14 (see (f) of FIG. 9). In this way, the voltage Vdd (=5V) is written into the node N2. And then, in order for the written voltage Vdd on the node N2 to be written into the node N1, the second refresh switch 66 becomes on-state during the period from the instant t15 to the instant t16 (see (e) of FIG. 9). If the second refresh switch 66 becomes on-state, the written voltage Vdd on the node N2 is supplied to the node N1 through the second refresh switch 66. This is shown by an arrow W3 in FIG. 9. As a result of this, the voltage on the node N1 changes from Vss to Vdd during the period from the instant t15 to the instant t16 (see (b) of FIG. 9). In this way, the voltage Vdd is written into the node N1. Comparing FIG. 8 with FIG. 9, it is understood that in FIG. 8, the voltage Vss (=0V) is written into the node N1 during the period from the instant t15 to the instant t16, but in FIG. 9, the voltage Vdd (=5V) is written into the node N1 during the period from the instant t15 to the instant t16.

After that, the first and second refresh switches 65 and 66 become on-state alternately in the similar way, so that the voltages Vss (=0V) and Vdd (=5V) are alternately written into the node N1 during the refresh period (refresh).

The written voltage Vss (=0V) and/or Vdd (=5V) on the node N1 are supplied as the inverted voltage, Vdd and/or Vss, to the processing circuit by making the pixel switch 10 on-state in the similar way as FIG. 8. In FIG. 9, the first refresh switch 65 is in the on-state e.g. during the period from the instant t9 to the instant t10 (see (d) of FIG. 9) just as in the case of FIG. 8. Therefore, by making the pixel switch 10 on-state during the period from the instant t9 to the instant t10 (see (h) of FIG. 9), the voltage Vdd on the node N1 is supplied as the inverted voltage, Vss, to the processing circuit through the source line Sk. This is shown by the arrow U2 and an arrow R1 in FIG. 9. If the processing circuit receives the voltage Vss from the pixel, the processing circuit can recognize that the pixel has performed the sampling of the voltage Vlow during the sample period (sample), i.e., the pixel has performed the sampling of the data corresponding to the groove 101b of the fingerprint 101 or the background data unrelated to the fingerprint. In the similar way as the first embodiment, the processing circuit distinguishes between the data of the groove 101b of the fingerprint 101 and the background data, based on which pixel the received data Vss has been outputted from.

Since the first refresh switch 65 is in the on-state during the period from the instant t13 to the instant t14 (see (d) of FIG. 9), the pixel switch 10 may be made on-state during the period from the instant t13 to the instant t14 instead of the period form the instant t9 to the instant t10 (see (h) of FIG. 9). The voltage on the node N1 during the period from the instant t13 to the instant t14 is Vss (see (b) of FIG. 9), so that the inverted voltage, Vdd, is supplied to the processing circuit through the source line Sk. This is shown by the arrow U3 and an arrow R2 in FIG. 9. Therefore, depending on when the pixel switch 10 is made on-state, the voltage Vdd and/or the voltage Vss can be supplied to the processing circuit,.

Now, comparing FIGS. 8 and 9. If the pixel switch 10 is made on-state during the period from the instant t9 to the instant t10, the voltage Vdd is supplied to the processing circuit through the source line Sk in the case of FIG. 8, but the voltage Vss is supplied to the processing circuit through the source line Sk in the case of FIG. 9 (see the arrows U2 and R1 of FIGS. 8 and 9). Therefore, depending on whether the voltage received by the processing circuit is Vdd or Vss, the processing circuit can recognize that the voltage sampled during the sample period (sample) is greater than the threshold voltage Vth inclusive or is not greater than the threshold voltage Vth inclusive.

On the other hand, if the pixel switch 10 is made on-state during the period from the instant t13 to the instant t14 instead of the period from the instant t9 to the instant t10, the voltage Vss is supplied to the processing circuit in the case of FIG. 8, but the voltage Vdd is supplied to the processing circuit in the case of FIG. 9 (see the arrows U3 and R2 of FIGS. 8 and 9). Therefore, depending on whether the voltage received by the processing circuit is Vdd or Vss, the processing circuit can recognize that the voltage sampled during the sample period (sample) is greater than the threshold voltage Vth inclusive or is not greater than the threshold voltage Vth inclusive.

If the pixel switch 10 is made on-state during the period from the instant t9 to the instant t10 and during the period from the instant t13 to the instant t14, the processing circuit receives both voltages Vss and Vdd from the same pixel irrespective of whether the voltage sampled during the sample period (sample) is Vhigh or Vlow. However, if the voltage sampled during the sample period (sample) is Vhigh, each pixel outputs Vdd and Vss in this order (see FIG. 8), whereas if the voltage sampled during the sample period (sample) is Vlow, each pixel outputs Vss and Vdd in this order (see FIG. 9). That is to say, depending on whether the voltage sampled during the sample period (sample) is Vhigh or Vlow, the order in which each pixel outputs the voltages Vdd and Vss is changed. Therefore, if the processing circuit is constructed so as to grasp this order difference, the pixel switch 10 can be made on-state during the period from the instant t9 to the instant t10 and during the period from the instant t13 to the instant t14.

FIGS. 8 and 9 illustrates that the pixel switch 10 is made on-state during the period from the instant t9 to the instant t10 and/or during the period from the instant t13 to the instant t14 in order to supply the processing circuit with the voltage. However, the pixel switch 10 may be made on-state during the other period. For example, by making the pixel switch 10 on-state during the on-state of the first refresh switch 65 after the instant t16, the voltage Vdd or Vss can be supplied to the processing circuit. If the pixel switch 10 is made on-state even after the instant t16, the number of times that the processing circuit is supplied with the voltages from the same pixel can be increased, so that the processing circuit can receive more voltage values from the same pixel. In this case, the fingerprint data having higher accuracy can be obtained, e.g. if the processing circuit averages a plurality of voltage values received from the same pixel.

In this way, the data of the fingerprint 101 is captured by the fingerprint data capturing part 80, the captured data of the fingerprint 101 can be outputted to the processing circuit.

Next, how the pattern of the fingerprint 101 is displayed on the display screen 55 is discussed in FIGS. 8 and 9.

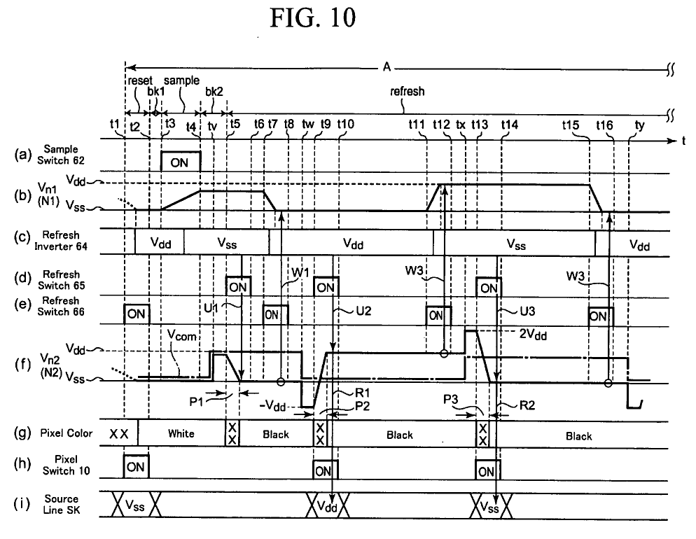

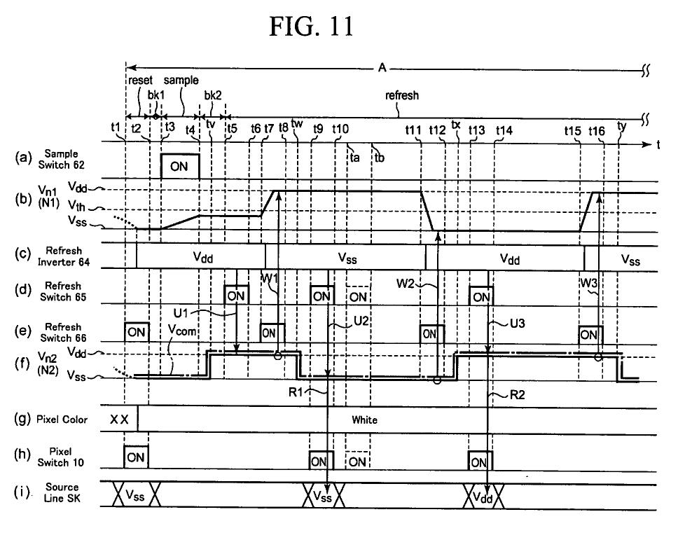

FIGS. 8 and 9 illustrate that the common electrode voltage Vcom is a constant voltage Vss (=0V) (see (f) of FIGS. 8 and 9). Now, comparing the voltage Vcom (=0V) with the voltage Vn2 on the node N2 (i.e. the voltage on the pixel electrode Ep) (see (f) of FIGS. 8 and 9), it is noted that the voltage Vcom is the constant voltage Vss (=0V), whereas the voltage Vn2 on the node N2 alternates between Vss (=0V) and Vdd (=5V). Therefore, a fixed voltage is not applied across the liquid crystal layer 52, but the voltages 0V and 5V are alternately applied across the liquid crystal layer 52. Since the liquid crystal layer 52 is normally white type, the pixel color is white when the voltage of 0V is being applied across the liquid crystal layer 52, and the pixel color is black when the voltage of 5V is being applied across the liquid crystal layer 52 (see (g) of FIGS. 8 and 9). Since a period during which the pixel color of white appears consecutively and a period during which the pixel color of black appears consecutively are very short, the user 150 viewing the screen 55 (see FIG. 7) can not visually recognize the difference between black and white of the pixels colors, so that he recognizes that the pixel color is gray color. This is common to FIGS. 8 and 9. Therefore, the user 150 recognizes that the pixel color is gray color irrespective of whether the voltage sampled during the sample period (sample) is Vhigh or Vlow. In this case, the user 150 recognizes that the color of the whole screen 55 is gray color, so that he can not recognizes the pattern of fingerprint. In the second embodiment, in order that the user 150 can recognize the pattern of the fingerprint, the common electrode voltage Vcom alternating between Vss (=0V) and Vdd (=5V) is supplied to the common electrode Ecom in the display operation OPdisplay. This example is described with reference to FIGS. 10 and 11.

FIGS. 10 and 11 show examples of timing diagrams (a) to (i) for a case where a common electrode voltage Vcom alternating between Vss(=0V) and Vdd(=5V) is supplied to the common electrode Ecom.

FIG. 10 shows the timing diagrams (a) to (i) obtained by using, in the timing diagrams of FIG. 8, the common electrode voltage Vcom alternating between Vss(=0V) and Vdd(=5V) instead of the common electrode voltage Vcom which is the constant voltage Vss. FIG. 11 shows the timing diagrams (a) to (i) obtained by using, in the timing diagrams of FIG. 9, the common electrode voltage Vcom alternating between Vss(=0V) and Vdd(=5V) instead of the common electrode voltage Vcom which is the constant voltage Vss.

First, referring to FIG. 10. A (f) of FIG. 10 shows the common electrode voltage Vcom (chain line) and the voltage Vn2 on the node N2 (solid line) which is obtained by supplying such common electrode voltage Vcom to the common electrode Ecom. In (f) of FIG. 10, a part of a waveform of the voltage Vcom is slightly displaced from a waveform of the voltage Vn2 for the purpose making the waveforms of the voltages Vn2 and Vcom visible.

Unlike FIG. 8, FIG. 10 shows that the common electrode voltage Vcom is not the constant voltage but the voltage alternating between Vss (=0V) and Vdd (=5V). If the voltages of Vss (=V) and Vdd (=5V) are alternately supplied to the common electrode Ecom, the voltage Vn2 on the node N2 dose not change as the solid lint in (f) of FIG. 8, but change as the solid lint in (f) of FIG. 10. Hereinafter, the voltage V2n on the node N2 shown in (f) of FIG. 10 is discussed.

The voltage of 5V is supplied to the common electrode Ecom during a period from an instant tv to an instant tw and during a period from an instant tx to and instant ty, and the voltage of 0V is applied to the common electrode Ecom during the other period.

At the instant tv, the first refresh switch 65 is in the off-state (see (d) of FIG. 10), so that the node N2 is not connected to both the power supply Vdd and Vss. Therefore, the voltage supplied to the common electrode Ecom is changed from Vss (=0V) to Vdd (=5V) at the instant tv, the voltage on the node N2 is accordingly changed from Vss (=0V) to Vdd (=5V). Since the first refresh switch 65 is changed from off-state to on-state immediately after the instant tv (i.e. at the instant t5) (see (d) of FIG. 10), the node N2 is connected to the power supply Vss, so that the voltage on the node N2 is changed from Vdd (=5V) to Vss (=0V) (see the arrow U1). After that, the voltage on the node N2 is kept Vss (=0V) until the voltage supplied to the common electrode Ecom is changed from Vdd (=5V) to Vss (=0V) at the instant tw. At the instant tw, the first refresh switch 65 is in the off-state (see (d) of FIG. 10), so that the node N2 is not connected to both the power supply Vdd and Vss. Therefore, if the voltage supplied to the common electrode Ecom is changed from Vdd (=5V) to Vss (=0V) at the instant tw, the voltage on the node N2 is accordingly changed from Vss (=0V) to −Vdd (=−5V). Since the first refresh switch 65 is changed from off-state to on-state immediately after the instant tw (i.e. at the instant t9) (see (d) of FIG. 10), the node N2 is connected to the power supply Vdd, so that the voltage on the node N2 is changed from −Vdd (=−5V) to Vdd (=5V) (see the arrow U2). After that, the voltage Vn2 on the node N2 is kept Vdd (=5V) until the voltage supplied to the common electrode Ecom is changed from Vss (=0V) to Vdd (=5V) at the instant tx. Since the first refresh switch 65 is in the off-state at the instant tx (see (d) of FIG. 10), the node N2 is not connected to both the power supply Vdd and Vss. Therefore, if the voltage supplied to the common electrode Ecom is changed from Vss (=0V) to Vdd (=5V) at the instant tx, the voltage on the node N2 is accordingly changed from Vdd (=5V) to 2 Vdd (=10V). Since the first refresh switch 65 is changed from off-state to on-state immediately after the instant tx (i.e. at the instant t13) (see (d) of FIG. 10), the node N2 is connected to the power supply Vss, so that the voltage Vn2 on the node N2 is changed from 2 Vdd (=10V) to Vss (=0V) (see the arrow U3). The voltage on the node N2 is kept Vss (=0V) until the voltage supplied to the common electrode Ecom is changed from Vdd (=5V) to Vss (=0V) at the instant ty. After that, the change in voltage described above is repeated. In this way, the display operation OPdisplay is performed.

As shown in FIG. 10, the potential difference between the common electrode Ecom and the node N2 is Vdd-Vss (i.e. 5V) after the instant t5 except for transition periods P1, P2, P3, . . . of the voltage Vn2 on the node N2. Therefore, the pixel color is undefined during the periods P1, P2, P3, . . . , but the pixel color is black if the potential difference between the common electrode Ecom and the node N2 is 5V. Since the periods P1, P2, P3, . . . are sufficiently short periods, the user 150 (see FIG. 7) can not recognize the pixel color during the periods P1, P2, P3, . . . when he views the display screen 55, so that he recognizes the pixel color of black after the instant t5. Therefore, if the pixel has performed the sampling of the voltage Vhigh (i.e. the sampling of data of the ridge 101a of the fingerprint 101), the user can recognizes that this pixel color of this pixel is black. This accords with a situation in which the ridge pattern FPr displayed on the screen 55 shown in FIG. 7 is black.

Next, FIG. 11 is discussed.

A (f) of FIG. 11 shows the common electrode voltage Vcom (chain line) and the voltage Vn2 on the node N2 (solid line) which is obtained by supplying such common electrode voltage Vcom to the common electrode Ecom. The voltage Vcom illustrated in (f) of FIG. 11 is the same as the voltage Vcom illustrated in (f) of FIG. 10. In FIG. 11 (f), a waveform of the voltage Vcom is slightly displaced from a waveform of the voltage Vn2 for the purpose of making the waveforms of the voltages Vn2 and Vcom visible.

At the instant tv, the first refresh switch 65 is in the off-state (see (d) of FIG. 11), so that the node N2 is not connected to both the power supply Vdd and Vss. Therefore, if the voltage supplied to the common electrode Ecom is changed from Vss (=0V) to Vdd (=5V) at the instant tv, the voltage on the node N2 is accordingly changed from Vss (=0V) to Vdd (=5V). After that, the voltage on the node N2 is kept Vdd (=5V) until the voltage supplied to the common electrode Ecom is changed from Vdd (=5V) to Vss (=0V) at the instant tw. At the instant tw, the first refresh switch 65 is in the off-state (see (d) of FIG. 11), so that the node N2 is not connected to both the power supply Vdd and Vss. Therefore, if the voltage supplied to the common electrode Ecom is changed from Vdd (=5V) to Vss (=0V) at the instant tw, the voltage on the node N2 is accordingly changed from Vdd (=5V) to Vss (=0V). After that, the voltage Vn2 on the node N2 is kept Vss (=0V) until the voltage supplied to the common electrode Ecom is changed from Vss (=0V) to Vdd (=5V) at the instant tx. At the instant tx, the first refresh switch 65 is in the off-state, the node N2 is not connected to both the power supply Vdd and Vss. Therefore, if the voltage supplied to the common electrode Ecom is changed from Vss (=0V) to Vdd (=5V) at the instant tx, the voltage on the node N2 is accordingly changed from Vss (=0V) to Vdd (=5V). The voltage on the node N2 is kept Vdd (=5V) until the voltage supplied to the common electrode Ecom is changed from Vdd (=5V) to Vss (=0V) at the instant ty. After that, the change in voltage described above is repeated. In this way, the display operation OPdisplay is performed.

As shown in FIG. 11, the potential difference between the common electrode Ecom and the node N2 is 0V during the period A, so that the pixel color is white as shown in (g) of FIG. 11. Therefore, if the pixel has performed the sampling of the voltage Vlow (i.e. the sampling of data of the groove 101b of the fingerprint 101 or data unrelated to the fingerprint 101), the user can recognizes that the pixel color of this pixel is white. This accords with a situation in which the groove pattern FPg and the background 57 displayed on the screen 55 shown in FIG. 7 are white.

By supplying the common electrode Ecom with the voltage Vcom illustrated in (f) of FIGS. 10 and 11, the pattern of the fingerprint 101 can be displayed on the display screen 55 as shown in FIG. 7.

In the explanation described above, it is based on the assumption that the fingerprint verification operation is performed in the environment where the intensity of the outer light Lout is weaker than the intensities of the reflected lights Lr and Lg, so that the background 57 is displayed in the same color as the groove 101b has (i.e. white). In contrast, assuming that the intensity of outer light Lout is stronger than the intensities of the reflected lights Lr and Lg, the background 57 would be displayed in the same color as the ridge 101a instead of the groove 101b (i.e. black). The user can visually recognize the pattern of the fingerprint 101 regardless of whether the background 57 is white or black.

In the second embodiment, after the sampling of the voltage Vhigh or Vlow is performed during the sample period (sample), the voltage Vss and/or Vdd is timely outputted to the processing circuit while the voltages 0V and 5V are alternately being written into the node N1. Therefore, the correct data of the fingerprint 101 is transmitted to the processing circuit.

In the second embodiment, the pixels P(1, k), P(2, k), . . . , P(m, k) simultaneously perform the operation of temporarily writing the voltage Vhigh or Vlow into the node N1, just as in the case of the first embodiment. Therefore, the fingerprint verification operation can be performed in a shorter time.

The display device 1 of the second embodiment connects the refresh inverter 64 to the liquid crystal capacitance Clc to temporarily store the voltage Vdd or Vss in the node N2, and then connects the node N2 to the node N1 to alternately write the voltages Vdd and Vss into the node N1. With such configuration, the number of the inverter required in the fingerprint data capturing part 80 is only one, so that it is possible to make the fingerprint data capturing part 80 compact in comparison with the display device 1 of the first embodiment which requires two inverters.

Further, the operation of supplying the voltage from the same pixel to the processing circuit may be performed two or more times to acquire two or more fingerprint data from the same pixel, and then a fingerprint data obtained by averaging such two or more fingerprint data may be compared with the original data of the fingerprint.

Further, the period A has the blank periods (bk1 and bk2). However, the blank periods may be omitted in so far as the correct data of the fingerprint 101 can be outputted to the processing circuit.

In the display devices 1 of the first and second embodiments, the second substrate 53 is provided with both the source lines and the gate lines, but the present invention is applicable to, for example, a display device in which one of substrates is provided with row electrode lines and the other is provided with column electrode lines. Further, the display devices I of the first and second embodiments are liquid crystal displays in which the liquid crystal material is sandwiched between the first substrate 51 and the second substrate 53, but the present invention is applicable to a display device (such as an organic EL display device) in which light-emitting material is sandwiched between substrates.

The display devices 1 of the first and second embodiments may be mobile phones or personal computers. Hereinafter, examples of applying the display device 1 to a mobile phone and a personal computer will be described below.

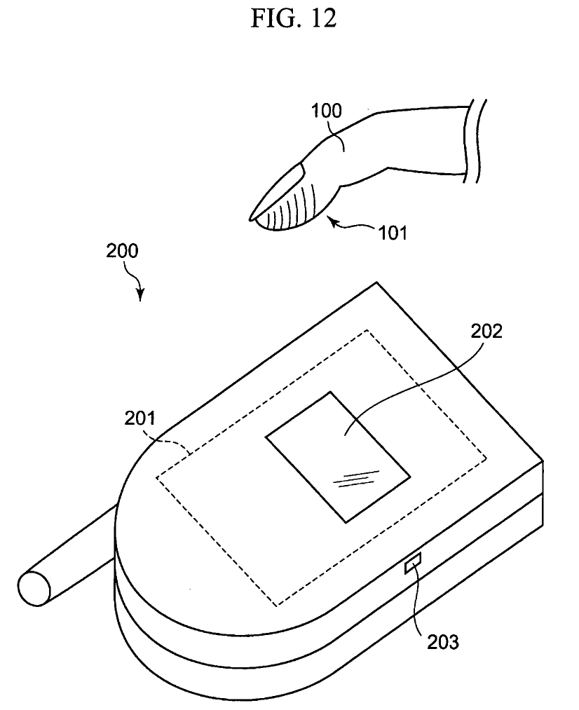

FIG. 12 shows an example of applying the display device 1 to the mobile phone 200.

In FIG. 12, the foldable mobile phone 200 comprising two screens 201 and 202 is illustrated in the folded form. The screen 201 of two screens 201 and 202 is provided at the inner surface and the other screen 202 is provided at the outer surface. Pixels provided in the screen 201 dose not comprise the fingerprint data capturing parts 20 and 80 as described in the first and second embodiments, but pixels provided in the screen 202 comprise the fingerprint data capturing parts 20 or 80 as described in the first or second embodiment. A fingerprint data of an owner of the mobile phone 200 is stored in the mobile phone 200. The owner can freely set the fingerprint verification function to enablement or disablement. In this embodiment, the fingerprint verification function of the mobile phone 200 is set to enablement. The mobile phone 200 comprises a fingerprint verification starting button 203 for starting a fingerprint verification period. If the fingerprint verification button 203 has been pressed, the mobile phone 200 starts the fingerprint verification operation which has been described with respect to the first and second embodiments. On the other hand, the user presses his finger 100 against the screen 202 in order to capture the data of the fingerprint 101 in the display device 1. The mobile phone 200 determines whether the fingerprint 101 matches with the registered fingerprint. If the fingerprint 101 matches with the registered fingerprint, the fingerprint verification operation is ended and a lock of the mobile phone 200 is released, so that the user can unfold the folded mobile phone 200, but if the fingerprint 101 dose not match with the registered fingerprint, the user can not unfold the mobile phone 200, so that the third party can not use the mobile phone 200 without the owner's permission.

By providing the pixels of the screen 202 with the fingerprint data capturing part 20 or 80 explained with respect to the first or second embodiment, the fingerprint verification can be performed in a short time. Further, since the mobile phone 200 can capture the data of the whole fingerprint 100 by only pressing the finger 100 against the screen 202, the user-friendly fingerprint verification operation is realized in comparison with the prior art mobile phone having a fingerprint sensor on which a finger must be slid. Further, since it is not necessary to provide fingerprint sensor outside the screen 202, upsizing of the mobile phone 200 can be prevented or relieved.

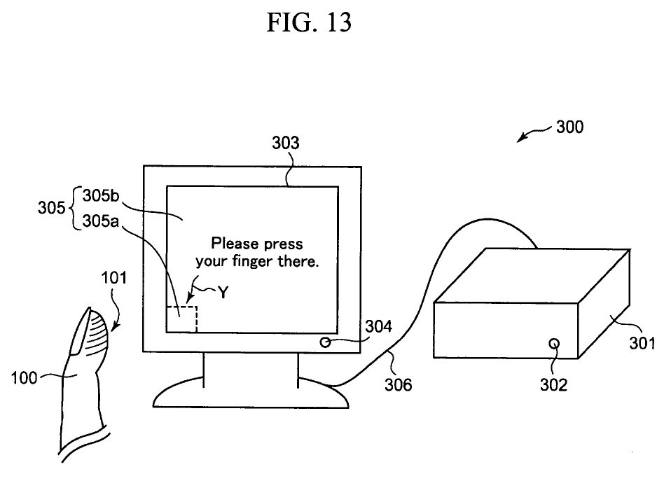

FIG. 13 shows an example of applying the display device 1 to a personal computer 300.

FIG. 13 illustrates a personal computer 300 comprising a main unit 301 and a display 303. The main unit 301 and the display 303 are connected to each other via a cable 306 allowing data to be transmitted bi-directionally. A screen 305 of the display 303 comprises a fingerprint capturing region 305a and a fingerprint non-capturing region 305b, the fingerprint capturing region 305a being provided with the fingerprint data capturing part 20 or 80 explained with respect to the first or second embodiment, and the fingerprint non-capturing region 305a being not provided with the fingerprint data capturing part 20 or 80 explained with respect to the first or second embodiment. A finger print data of an owner of the personal computer 300 is stored in the personal computer 300. The owner can freely set the fingerprint verification function to enablement or disablement. In this embodiment, the fingerprint verification function of the personal computer 300 is set to enablement. If the user has pressed a main power supply button 302 of the main unit 301 and the power button 304 of the display 303, the personal computer 300 displays at the lower-left area of the screen 305 of the display 303 a broken line for distinguishing the fingerprint capturing region 305a from the fingerprint non-capturing region 305b and displays within the fingerprint non-capturing region 305b an arrow Y and a sentence “Please press your finger there”, and the personal computer 300 starts the fingerprint verification operation explained with respect to the first and second embodiments. On the other hand, the user press his finger 100 against the fingerprint capturing region 305a of the screen 305 in accordance with a guide “Please press your finger” displayed on the screen 305 of the display 303. The personal computer 300 determines whether the fingerprint 101 matches with the registered fingerprint. If the fingerprint 101 matches with the registered fingerprint, the fingerprint verification operation is ended and the personal computer 300 is shifted to a normal operation. If the personal computer 300 is shifted to the normal operation, the fingerprint capturing region 305a as well as the fingerprint non-capturing region 305b are used as the display screen 305 which displays an image. On the other hand, if the fingerprint 101 dose not match with the registered fingerprint, the personal computer 300 will shut down.

If an area of the screen 305 is considerably larger than an area of the fingerprint 101 as shown in the personal computer 300, the fingerprint data capturing part 20 or 80 explained with respect to the first or second embodiment may be provided in pixels existed only within region 305a which seems to be sufficient to capture the data of the fingerprint 101, instead of all pixels of the screen 305. By providing such fingerprint data capturing part 20 or 80, the fingerprint verification can be performed in a short time. Further, since the personal computer 300 can capture the data of the fingerprint 101 by only pressing the finger 100 against the screen 305 of the display 303, it is not necessary to prepare the fingerprint sensor as a peripheral equipment for the personal computer 300, so that complexity of an overall system which includes the personal computer 300 may be prevented or reduced.

### LIST OF REFERENCE NUMERALS

1 Display device
10 Pixel switch
11,61 Photodiode
12, 62 Sample switch
13, 63 Holding capacitor
14, 16, 17, 65, 66 Refresh switch
15 Refresh buffer
15a, 15b, 15c, 15d, 64a, 64b Transistor
18 Refresh means
19 Readout switch
20, 80 Fingerprint data capturing part
51, 53 Substrate
52 Liquid crystal layer
54 Backlight
55 Display screen
55a Region
57 Background
64 Refresh inverter
100 Finger
101 Fingerprint
101a Ridge
101b Groove
150 User
151, 152 Inverter
200 Mobile phone
201, 202 Screen
203 Fingerprint ID starting button
300 Personal computer
301 PC main body
302 Main power button
303 Display
304 Power button
305 Screen
305a Fingerprint capturing region
305b Fingerprint non-capturing region
306 Cable

1. A display device provided with a pixel or sub pixel comprising:
a light detecting means for detecting light from an object;
a holding means for holding a first data corresponding to an intensity of said light detected by said light detecting means; and
a refreshing means for writing a second data into said holding means on the basis of said first data held by said holding means.

2. A display device as claimed in claim 1, wherein said holding means holds said first data as a physical quantity.

3. A display device as claimed in claim 2, wherein said physical quantity is voltage.

4. A display device as claimed in claim 3, wherein said pixel region or said sub pixel region is further provided with a converting means for converting light detected by said light detecting means into voltage.

5. A display device as claimed in claim 4, wherein when said converting means converts light detected by said light detecting means into a voltage smaller than a predetermined voltage, said refresh means writes a first voltage smaller than said predetermined voltage in said holding means, and wherein when said converting means converts light detected by said light detecting means into a voltage larger than said predetermined voltage, said refresh means writes a second voltage larger than said predetermined voltage in said holding means.

6. A display device as claimed in claim 5, wherein when said converting means converts light detected by said light detecting means into a voltage smaller than said predetermined voltage, said refresh means continues to write said first voltage in said holding means, and wherein when said converting means converts light detected by said light detecting means into a voltage larger than said predetermined voltage, said refresh means continues to write said second voltage in said holding means.

7. A display device as claimed in claim 5, wherein said refresh means alternately writes said first and second voltages in said holding means.

8. A display device as claimed in claim 1, wherein said second data is the same as said first data or different from said first data.

9. A display device as claimed in claim 1, wherein said display device comprises a reference data compared with said second data, and wherein said display device determines whether said second data is equal to said reference data.
